(19) United States
(12) Patent Application Publication
(10) Pub. No.: US 2016/0203469 A1
(43) Pub. Date: Jul. 14, 2016

(54) SYSTEM AND METHOD OF FACILITATING MONETARY TRANSACTIONS

(71) Applicant: Mohamed Yaya Cisse, Bronx, NY (US)

(72) Inventor: Mohamed Yaya Cisse, Bronx, NY (US)

(21) Appl. No.: 14/951,913

(22) Filed: Nov. 25, 2015

Related U.S. Application Data
(60) Provisional application No. 62/101,814, filed on Jan. 9, 2015.

(51) Int. Cl. G06Q 20/32; G06Q 20/40; G06K 9/18; G06Q 20/36

(52) U.S. Cl. CPC G06Q 20/3274; G06Q 20/363; G06Q 20/401; G06K 9/18

(57) ABSTRACT

A system and method for facilitating monetary transaction is provided. The system and method utilizes a remote communication device. The remote communication device includes a display and a subscriber identity module. The remote communication device further includes a wireless network capability as well as a processor and memory. The processor is operable to transform a subscriber identity module card number of the subscriber identity module into a computer scannable code. The computer scannable code may include a barcode, such as a matrix barcode. The computer scannable code is produced on the display. A merchant scans the computer scannable code to retrieve financial account information of a user.

### CROSS-REFERENCE TO RELATED APPLICATION

This application claims the benefit of priority of U.S. provisional application No. 62/101,814, filed Jan. 9, 2015, the contents of which are herein incorporated by reference.

### BACKGROUND OF THE INVENTION

The present disclosure relates generally to techniques for conducting transactions, and more particularly to techniques for conducting point of sale transactions over a remote connection.

While the memory card concept has been in existence since the early 1970's, the first automated chip card was not invented until the 1980's. In 1983, a French inventor created the first known automated chip card (smart card). The earliest mass use of the smart card was for facilitating payment for use of French pay phones. The second known use of smart card technology occurred nearly a decade later with a French payment card, which facilitated PIN-less payment transactions at toll roads. Soon thereafter, smart cards became widely implemented in markets having a need for highly secure portable tokens capable of facilitating financial transactions.

As the smart card was gaining traction in the financial services market, the first Subscriber Identity Module (SIM) card was produced by a Munich smart card manufacturer. A Finnish wireless network carrier was the first to implement the SIM card to allow mobile devices to access and operate within the operator's network. Other network carriers followed soon thereafter, utilizing SIM cards to connect mobile devices to their cellular networks and provide subscribers with universally available services such as call roaming.

Increasing consumer demands for alternative payment options combined with a desire by merchants to accept electronic payments with limited restrictions have led to a number of innovations directed toward mobile payments. Likewise, hardware and software developers have sought to expand the functionality of mobile devices to close gaps between buyers and sellers. These efforts produced newer generations of data compression and wireless networking protocols, enabling existing radio-based networks to efficiently move large amounts of data. While tremendous advancements have been made in this regard, questions remain as to how to most effectively protect the integrity of sensitive data as it traverses data networks.

Consumers and merchants have benefited from the convenience of electronic commerce on a larger scale; however, the full promise of mobile payment has not been realized due to remaining deficiencies in the ability to secure sensitive information. Islands of technology remain, which have not been bridged by secure, reliable, and efficient communication architectures. In other words, the ability to create and consume meaningful data at a mobile device has outpaced the ability to securely move that data from point to point over a network.

Consumer transactions require a customer to select a product from a store shelf, and then to check them out at a checkout counter. Product information is entered into a point-of-sale terminal device, or the information is entered automatically by scanning an item barcode with an integrated barcode scanner, and the customer is usually provided with a number of payment options, such as cash, check, credit card or debit card. Once payment is made and approved, the point-of-sale terminal memorializes the transaction in the merchant's computer system, and a receipt is generated indicating the satisfactory consummation of the transaction.

Payment cards such as credit or debit cards are ubiquitous and for decades such cards have included a magnetic stripe on which the relevant account number is stored. Traditionally, to consummate a purchase transaction with such a card, the card is swiped through a magnetic stripe reader that is part of the point of sale (POS) terminal. The reader reads the account number from the magnetic stripe. The account number is then used to route a transaction authorization request that is initiated by the POS terminal.

Today, these card-based transactions are typically performed across multiple channels of commerce. For example, card-based transactions may be performed in person at a retail outlet, via a computer connected to the internet, via a mobile phone and/or via a company-based call center (e.g., a 1-800 number for a catalog company). These various transactions are conducted in different ways and, accordingly, have different levels of fraud risk associated therewith. In addition, transactions generally require that the consumer have his or her card in hand to either present to the cashier in a retail environment, or to enter the requested information via the internet and/or over the telephone. Those knowledgeable in the field will recognize that the risk of financial fraud is greater during remote transactions (also known as “card not present” transactions) because there is less ability for the merchant to verify the identity and authenticity of the cardholder.

In attempts to provide an additional security layer for online credit and debit card transactions, several different protocols have been adopted by payment card networks. For example, MasterCard International Incorporated provides the MasterCard SecureCode service. Other payment networks use similar services, generally based on the 3-D secure protocol. Each of these services generally add an additional online authentication process to the standard financial authorization process to reduce fraud in card not present transactions, including electronic commerce (“e-commerce”) and mobile commerce (“m-commerce”) transactions.

Such authentication processes provide a greater level of authentication during transactions. Unfortunately, however, such processes can be unwieldy and involve a large number of messages and participants. It would be desirable to provide online transaction processes that reduce fraud and risk, while minimizing the interactions and complexity of transactions. Further, it would be desirable to reduce the integration requirements of acquiring and authorizing such transactions, while allowing proximity payment transactions at point of sale locations as well as transactions at remote terminals (e.g., over the Internet).

The types and nature of remote transactions are also changing. For example, some of the fastest growing types of remote transactions are transactions involving a mobile device such as a mobile telephone. It would be desirable to provide transaction systems and methods which allow for increased convenience in such remote transactions, including those involving a mobile device.

### SUMMARY OF THE INVENTION

In general, the present invention overcomes the limitations and problems of prior art systems by providing a system and device that eliminates the need to accommodate both a personal token card (and card reader) and a network SIM card within a mobile device, herein referred to as a “communication device.” The invention combines the features of these two smart card architectures to create a Network Access and Credential Verification (NACV) module, capable of facilitating secure and convenient electronic transactions with minimal dependence on additional hardware.

The inventions provides for a safe and secured way to money transaction without any added cost of installing any new hardware. The hardware used in the current invention are generally available at most of the payment portals/stores and include: Webcam/bar code reader, a cell phone with SIM linked up with the credit card details and an software password protected for generation of a Matrix code for Verification of the authenticity of the payer at the bank (distant payment body).

A communication device (e.g., cellular phone) equipped with the NACV module may, for example, also function as a transaction instrument reader (e.g., a Point of Sale terminal). Accordingly, the invention includes an application is installed at the communication device. Specifically, this software provides an interface for entry of a Personal Identification Number (PIN) and in particular it scans the SIM of the Phone which is already linked with the credit card of the phone holder/user and is password protected app. When the software button is clicked and password is entered, it generates a matrix code on the screen of the phone. The webcam/ barcode reader at the store reads the matrix code and send the data to the payment gateway or banks for verification. Once verified the desired payment is completed safely.

In one aspect of the present invention, a system for facilitating a monetary transaction comprises: a remote communication device comprising: a display; a wireless network capability; a subscriber identity module card comprising a subscriber identity module card number; and a processor operable to transform the subscriber identity module card number into a computer scannable code, wherein the computer scannable code is produced on the display.

In another aspect of the present invention, a method for facilitating a monetary transaction comprises: producing a computer scannable code comprising a subscriber identity module card number stored on a subscriber identity module card via software run a computer; and displaying the computer scannable code on a display of a remote communication device comprising a wireless network capability.

These and other features, aspects and advantages of the present invention will become better understood with reference to the following drawings, description and claims.

### BRIEF DESCRIPTION OF THE DRAWINGS

FIG. 1 is a schematic view of an embodiment of the present invention; and

FIG. 2 is a process flow chart of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

In general, the present invention uniquely provides an efficient and highly secure means for facilitating identity verification and transaction authorization. More specifically, the disclosed system and device provides a secure means for communicating various forms of information from a remote communication device. Accordingly, and in one embodiment, the invention combines the functionality of a standard SIM with that of a smart card based personal token to allow a user to provide authentication credentials, select a transaction instrument, and authorize a transaction in the form of a matrix code.

A communication device (e.g., cellular phone), as used herein, includes a unique Network Access and Credential Verification (NACV) module that is a single-device solution combining the features of a GSM, 4G, or other wireless network SIM with those of a smart card based personal token, such as a CAC or PIV card, and a financial payment instrument, such as an EMV credit card. The NACV module enables the communication device to simultaneously provide wireless network functions and personal token functions including, for example, cryptographic key establishment, management digital signatures, identity validation, secured communications, legal non-repudiation, authenticated and secured payment transactions, and a variety of access control capabilities.

An authorization process may be invoked by software (such as an application on the smart device) by a requesting an entity (e.g., a POS device or gateway server) sending an authorization request to a communication device. Receipt of an authorization request invokes the software of the communication device, which prompts the user for authorization. The authorization process may comprise a single factor such as, for example, a positive affirmation by the user. However, the authorization may comprise multiple factors, such as entry of a PIN and/or presentation of a biometric sample (e.g., voiceprint). Entry of authorization credentials invokes creation of an authorization response. The authorization response may be transmitted back to the requesting entity along the same path as the payment authorization request and the user is allowed to log in the software and leading to generation of a matrix code.

As used herein, a “communication device” may comprise any hardware, software, or combination thereof, configured to invoke and/or facilitate communication and/or transactions over a carrier network. More specifically, it should be noted that the communication device may be embodied as any combination of hardware and/or software components configured to interact with various other hardware and/or software components to facilitate the disclosed identity verification and electronic payment features. For example, the communication device may include the physical form of the disclosed NACV module and/or software modules maintained within any electronic or physical memory structure. Moreover, practitioners will appreciate that the terms “communication device”, “NACV module”, “transaction instrument”, “smart phone”, “mobile phone”, and “cell phone” be used interchangeably without departing from the scope of the invention.

As used herein, the terms “user,” “end user,” “consumer,” “customer”, “cardholder”, “account holder”, or “participant” may be used interchangeably with each other, and each shall mean any person, entity, machine, hardware, software, and/or business. Furthermore, the terms “business” or “merchant” may be used interchangeably with each other and shall mean any person, entity, machine, hardware, software, or business. Further still, the merchant may be any person, entity, software, and/or hardware that is a provider, broker, and/or any other entity in the distribution chain of goods or services.

In one embodiment, the user equipped with the communication device may invoke a purchase transaction based on a selected transaction account without providing sensitive account information to a merchant or merchant POS device. As such, there is no need to collect sensitive Peripheral Component Interconnect (PCI) controlled account holder data (i.e., Visa, MasterCard, American Express, etc.) at the POS device. Because of this, purchase transactions facilitated in accordance with the various embodiments are inherently more secure than traditional electronic payment transactions. For example, theft of transaction account information is meaningless because the transaction instrument is inextricably linked to the user and his communication device. A fraudster cannot use the transaction account unless he is in physical possession of the transaction account holder's communication device and has knowledge of the associated PIN. The PIN or password may be used only for accessing the cell phone of the user or within a communication device interface when a selected transaction instrument is used to facilitate a PIN-less transaction such as, for example, by way of a credit card. Because participating merchants are not bound by the PCI requirements and liability issues associated with traditional transaction instruments, merchants benefit from the use of the disclosed module.

As described above, a PIN may be used with the communication device even when the “authorization” account is a credit card account. The addition of the PIN provides an additional layer of security to the use of the communication device.

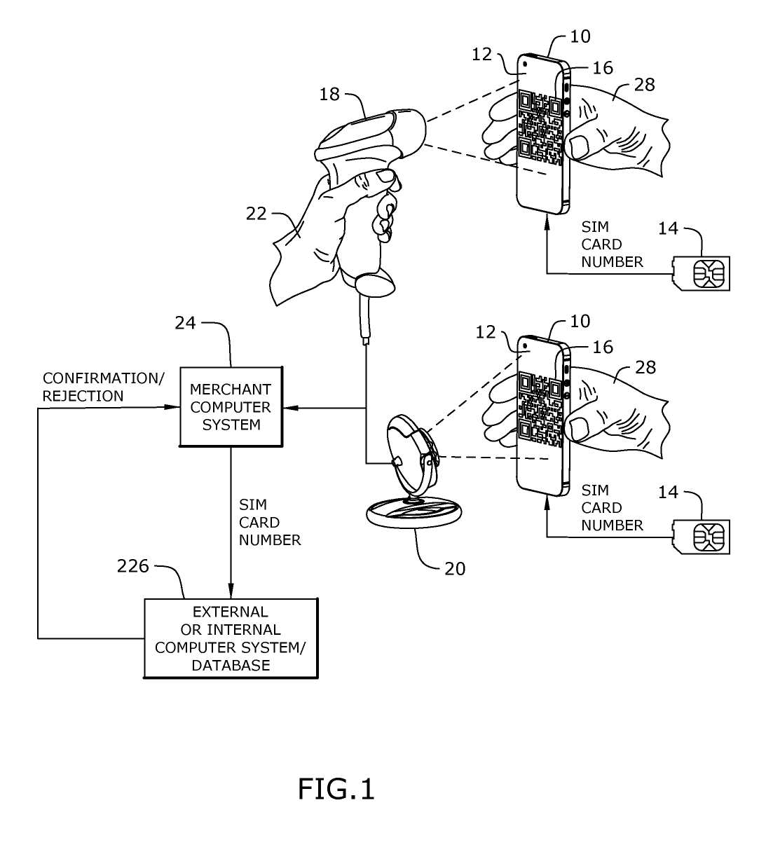

Referring to FIG. 1, the present invention includes a remote communication device 10. The remote communication device 10 includes a display 12 and a subscriber identity module 14. The remote communication device 10 further includes a wireless network capability as well as a processor and memory. The processor is operable to transform a subscriber identity module card number of the subscriber identity module 14 and transform the identity module card number into a computer scannable code 16. The computer scannable code 16 may include a barcode, such as a matrix barcode. The computer scannable code 16 is produced on the display 12.

The identity module card number of the subscriber identity module 14 may is linked to financial institution account information of a user 28, such as credit/debit card information. At least one of a camera 20, such as a webcam, and a bar code reader 18 is used to scan the computer scannable code 16 by a merchant 22. Once the computer scannable code 16 is scanned, a merchant computer system 24 retrieves the identity module card number. The identity module card number is then sent from the merchant computer system 24 to an external or internal computer system/ database 226. The database 226 verifies the linked financial institution account information and confirms or rejects the user's use of the identity module card number, thereby authorizing or denying the payment to the merchant 22.

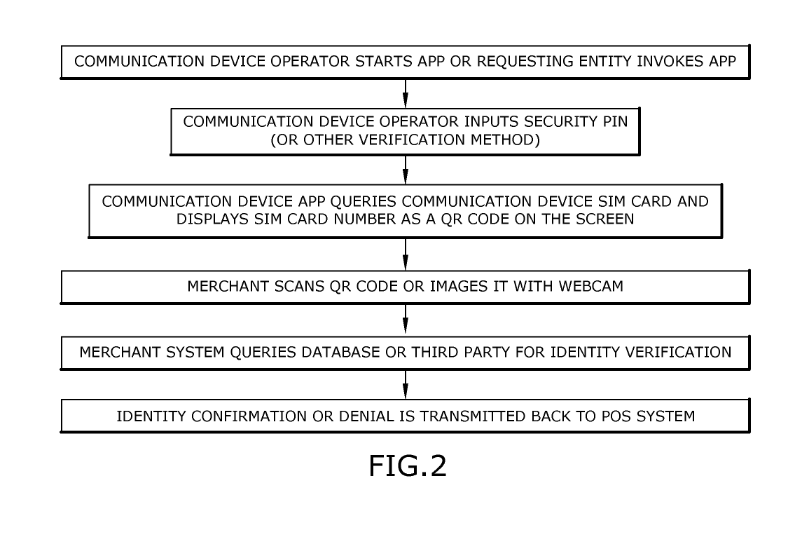

Referring to FIG. 2, another aspect the invention provides a method for performing mobile transactions including the following steps. A user may downloads the an application on his cell phone , which may be password protected and has all the personal details including the credit/debit card details linked up with the SIM of the Phone used by the user. Second step is that to make a mobile transaction the user does the login in application and which generates the matrix code. Then the merchant scans this code using the webcam or the bar code which sends data to the bank for verification and lastly payment is completed.

A communication device (e.g., cellular phone) equipped with the NACV module may, for example, also function as a transaction instrument reader (e.g., a Point of Sale terminal). Accordingly, the invention includes an application is installed at the communication device.

Specifically, this software provides an interface for entry of a Personal Identification Number (PIN) and in particular it scans the SIM of the Phone which is already linked with the credit card of the phone holder/ user and is password protected app. When the software button is clicked and password is entered, it generates a matrix code on the screen of the phone. The webcam/ barcode reader at the store reads the matrix code and send the data to the payment gateway or banks for verification. Once verified the desired payment is completed safely.

Instead of swiping a credit card or using RDFI chip which requires merchants to upgrade their systems at a high expense. The software will generate a Matrix code that can be scanned. The Matrix code will work similar to a credit card strip that sends the details to the financial institution while at the store.

The module discussed in the current invention can be easily used for other functions like connecting the SIM details of the user with the Employee code and using it as an access card in offices, as a metro card and as credit card.

It should be understood, of course, that the foregoing relates to exemplary embodiments of the invention and that modifications may be made without departing from the spirit and scope of the invention as set forth in the following claims.

What is claimed is:

1. A system for facilitating a monetary transaction comprising:
a remote communication device comprising:
a display;
a wireless network capability;
a subscriber identity module card comprising a subscriber identity module card number; and
a processor operable to transform the subscriber identity module card number into a computer scannable code, wherein the computer scannable code is produced on the display.

2. The system of claim 1, wherein the subscriber identity module card number is linked to data comprising a financial payment account information.

3. The system of claim 2, further comprising:
a payment portal comprising a merchant computer system and at least one of a camera and a bar code reader operable to read the computer scannable code and send the subscriber identity module card number to a database to verify and retrieve the financial payment account information linked to the subscriber identity module card number.

4. The system of claim 1, wherein the computer scannable code is a matrix barcode.

5. A method for facilitating a monetary transaction comprises:
producing a computer scannable code comprising a subscriber identity module card number stored on a subscriber identity module card via software run a computer; and
displaying the computer scannable code on a display of a remote communication device comprising a wireless network capability.

6. The method of claim 5, wherein the subscriber identity module card number is linked to data comprising a financial payment account information.

7. The method of claim 5 further comprising the steps of:
scanning the computer scannable code using at least one of a camera and a bar code reader of a merchant payment portal, thereby accessing the subscriber identity module card number; and
verifying the financial payment account information and thereby facilitating the monetary transaction.
